(19) United States
(12) Patent Application Publication
(10) Pub. No.: US 2013/0346673 A1
(43) Pub. Date: Dec. 26, 2013

(54) METHOD FOR IMPROVING FLASH MEMORY STORAGE DEVICE ACCESS

(71) Applicant: Yi-Chou Chen, Hsinchu City (TW)

(72) Inventor: Yi-Chou Chen, Hsinchu City (TW)

(21) Appl. No.: 13/531,589

(22) Filed: Jun. 25, 2012

(51) Int. Cl. G06F 12/02

(52) U.S. Cl. 711/103; 711/E12.008

(57) ABSTRACT

A method for improving flash memory storage device access is disclosed. The steps of the method comprises requesting to read/write data of logical address by a host; setting up an engine by a CPU; looking up physical address and updating at least one table stored in at least one flash memory by the engine; and reading/writing data from/to the at least one flash memory. Thereby, the engine is accessing the data from each table in parallel to significantly reduce the total operation time.

### FIELD OF THE INVENTION

The present invention provides a method for reducing the number cycle of tables' lookup, file system information, flash erase information searching.

### BACKGROUND OF THE INVENTION

Now a day, flash memories are very common in storage system. Varies kind of memory technology makes different flash type. NAND flash memory is one of the most popular memory devices for storage. With advantage of high speed, high density, and low power consumption, and low cost, so NAND flash is widely used in mobile system, including mobile phone, MP3 player, digital camera, tablet PC, etc. However, there are additional physical constraints to access flash memory. It is necessary to erase the flash memory before programming it. The minimum erase unit is block, which contains lot of pages. The minimum program unit is page and the pages inside the same block shall program sequentially. To meet the physical constraint, many algorithms are proposed to solve issues on performance and the usage of blocks and pages.

Embedded processor takes longer time to look up the table while the algorithms become more complex, the size of flash become larger. Also, the access performance requirement rises rapidly with time. The long table look up time would be critical enough to be the bottleneck of flash access performance.

Today embedded processor is used to implement the algorithm and maintain the tables. However, processor takes a lot time to access the data and do the lookup. It results in long overhead for each host access.

Please refer to FIGS. 1 and 2, which FIG. 1 is illustrated a flow chart of conventional method for flash memory storage device access, and FIG. 2 is illustrated a block diagram of conventional flash memory storage access.

The steps of conventional method of flash memory storage device access comprise as below.
step S11: requesting to read/write data of logical address by a host (not shown);
step S12′: looking up the physical address and updating the at least one table 30′ stored in a flash memory 3′ by a CPU 1′; and
step S13′: reading/writing data from/to the flash memory 3′.

Wherein, the CPU 1′ is connecting to the flash memory 3′ with the at least one table 30′ by a processor bus 2′, and the processor bus 2′ can be a 32-bit data bus, but not limited thereto.

Please also refer to FIG. 3, which is illustrated an example of the conventional method for flash memory storage device access.

The steps are as below.
step S21′: reading info 1n from the tables;
step S22′: comparing info 1n and the data of the flash memory; if not matches, back to step S21′; if matches, continue to next step;
step S23′: reading info 2n from the tables;
step S24′: comparing info 2n and the data of the flash memory; if not matches, back to step S23′; if matches, continue to next step;
step S25′: triggering flash memory access; and
step S26′: updating info to the tables.

Therefore, the steps are running sequentially. Generally, the table size is large based on different algorithm. And processor only work on memory access 1-by-1, and do the comparison step by step. The memory access may have long latency and the comparison may take multiple instructions and cycles. The total time to find out a matched result in each table and trigger the flash memory access is long.

### SUMMARY OF THE INVENTION

An objective of this invention is providing a method for improving flash memory storage device access, which is capable of speeding up the table lookup, searching, and updating process by dedicate hardware and with wide bus to shorten the overhead for every read/write access from the host to the flash memory, and then improving TO number per second and performance of storage device access.

To achieve above objectives, a method for improving flash memory storage device access, the steps comprising:
requesting to read/write data of logical address by a host;
setting up an engine by a CPU;
looking up physical address and updating at least one table stored in at least one flash memory by the engine; and
reading/writing data from/to the at least one flash memory.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is illustrated a flow chart of conventional method for flash memory storage device access.

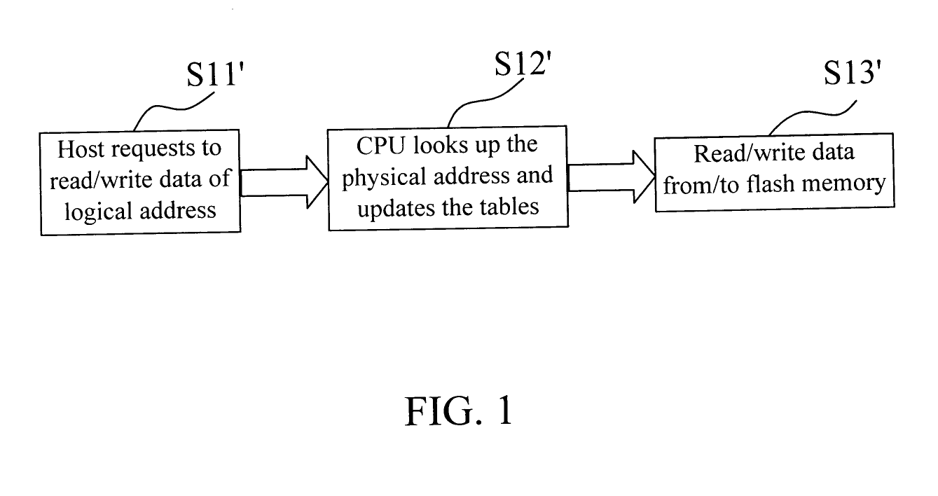

FIG. 2 is illustrated a block diagram of conventional flash memory storage access.

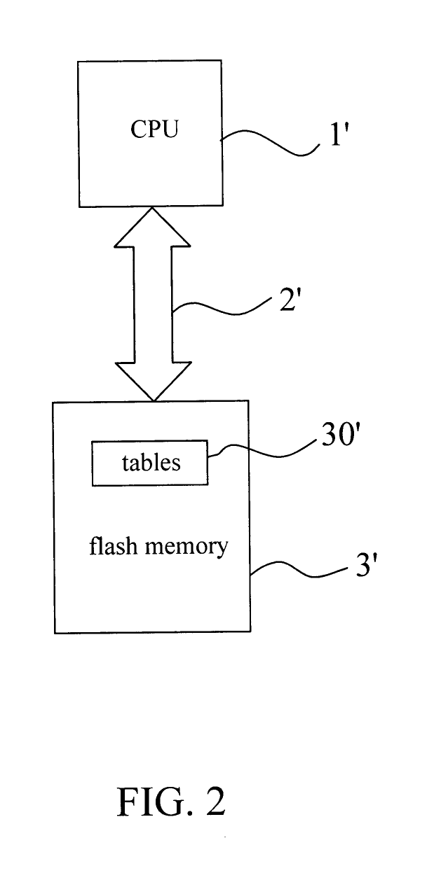

FIG. 3 is illustrated an example of the conventional method for flash memory storage device access.

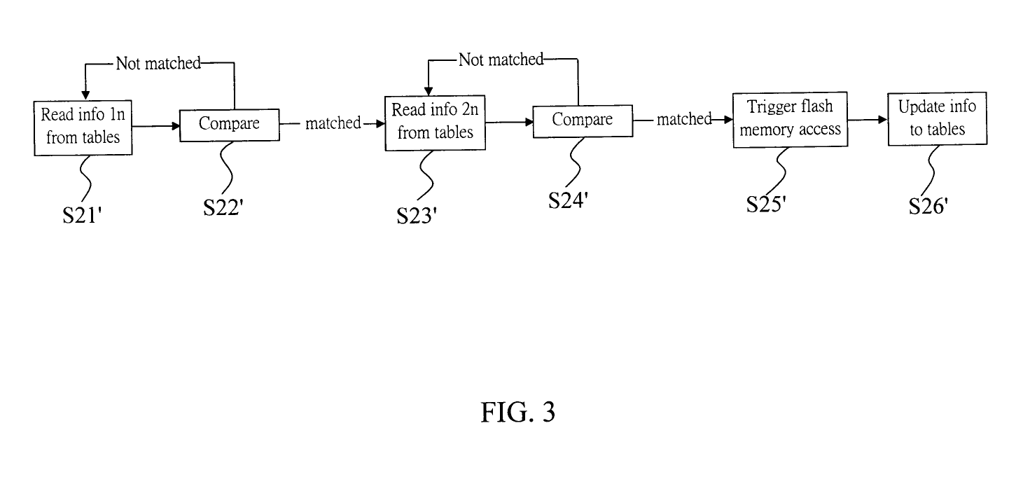

FIG. 4 is illustrated a flow chart of a method for flash memory storage device access according to the present invention.

FIG. 5 is illustrated a block diagram of flash memory storage access according to the present invention.

FIG. 6 is illustrated an example of the method for flash memory storage device access according to the present invention.

### DESCRIPTION OF THE PREFERRED EMBODIMENT

Referring now to the drawings where like characteristics and features among the various figures are denoted by like reference characters.

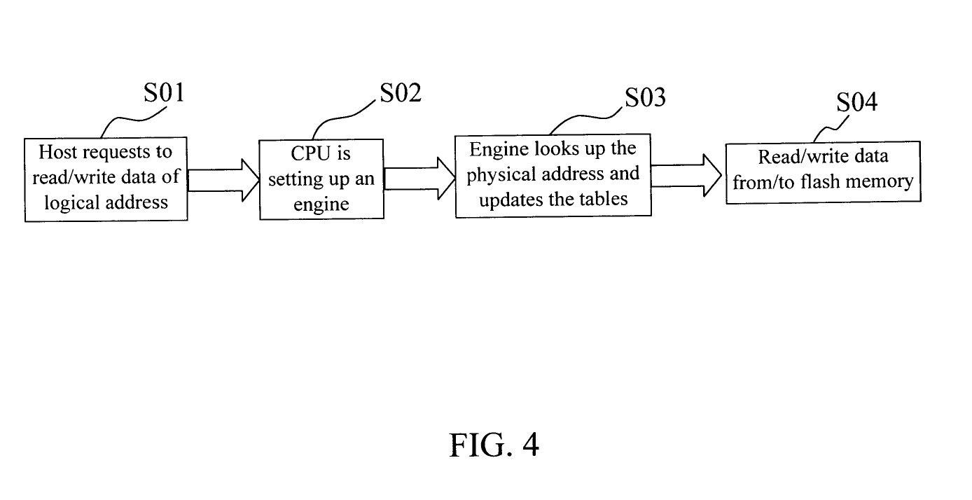

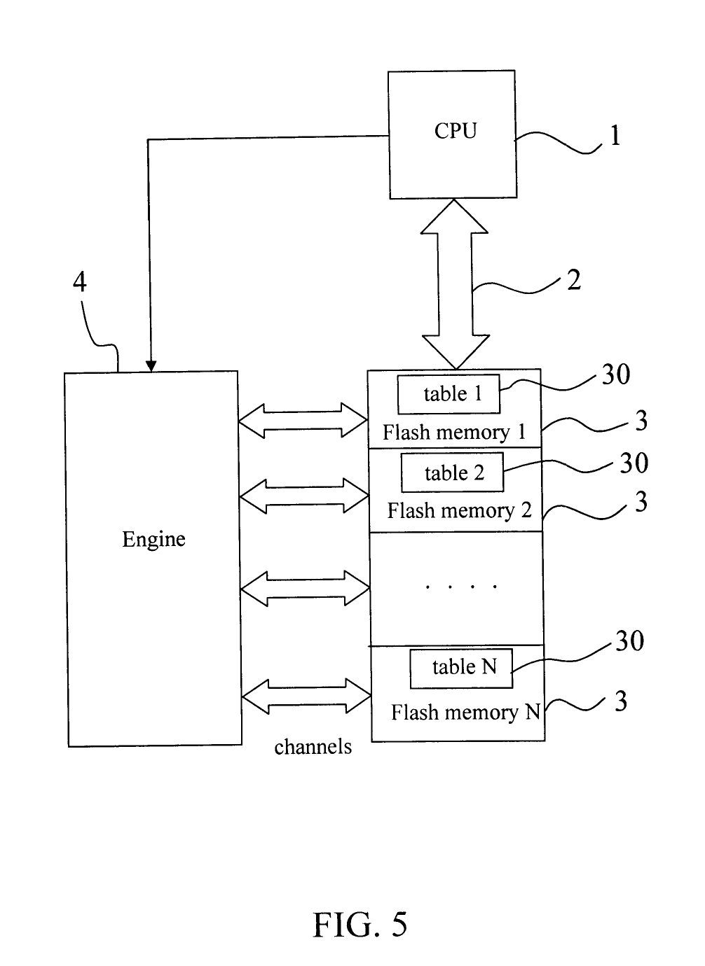

Please refer to FIGS. 4 and 5, which FIG. 4 is a flowchart showing a method for flash memory storage device access according to the present invention, and FIG. 5 is illustrated a block diagram of flash memory storage access according to the present invention.

The steps for the process of a method for flash memory storage device access according to the present invention are:
step S01: requesting to read/write data of logical address by a host (not shown);
step S02: setting up an engine 4 by a CPU 1;
step S03: looking up physical address and updating at least one table 30 stored in at least one flash memory 3 by the engine 4; and
step S04: reading/writing data from/to the at least one flash memory 3.

Wherein, the CPU 1 is connecting to the flash memory 3 with the at least one table 30 by a processor bus 2, and the processor bus 2 can be a 32-bit data bus, but not limited thereto.

In one embodiment, each table 30 is stored in each flash memory 3 one-to-one (shown as FIG. 5). Therefore, the engine is connecting to the plenty of flash memories by plenty of channels 5 independently.

In another embodiment, each table is stored in one flash memory (not shown).

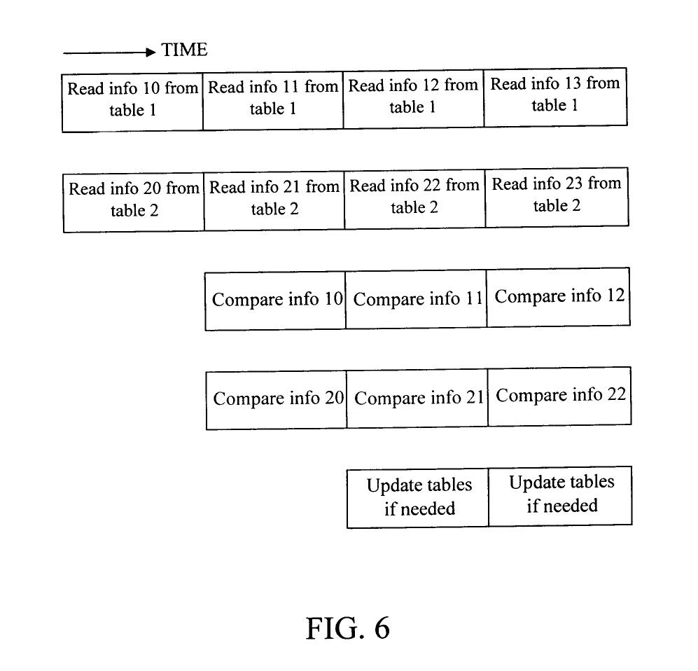

Please also refer to FIG. 6, which is illustrated an example of the method for flash memory storage device access according to the present invention.

Once the target patterns are setup and triggers the engine, the engine is accessing the data (info 10-13 and info 21-23) from each table (table 1-2) in parallel, pipelining with data comparing hardware circuit, and may also update to another table shown as FIG. 6.

Due to dedicated design for the specified algorithm and well pipelined, every operation could be done in every cycle. The total time of operation is significantly reduced.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A method for improving flash memory storage device access, the steps comprising:
requesting to read/write data of logical address by a host;
setting up an engine by a CPU;
looking up physical address and updating at least one table stored in at least one flash memory by the engine; and
reading/writing data from/to the at least one flash memory.

2. The method as claimed in claim 1, wherein each table is stored in each flash memory one-to-one.

3. The method as claimed in claim 1, wherein each table is stored in one flash memory.
